(19) United States
(12) Patent Application Publication
(10) Pub. No.: US 2006/0204926 A1
(43) Pub. Date: Sep. 14, 2006

(54) Contra-angle used for endodontology

(76) Inventor: Jean-Marie Badoz, Doubs (FR)

Correspondence Address: Gary M Cohen;Strafford Building Number Three, Suite 300, 125 Strafford Avenue, Wayne, PA, 19087-3318, US

(21) Appl. No.: 10/567,166

(22) PCT Filed: Jun. 30, 2004
(86) PCT No.: PCT/FR04/01670

§ 371 Date: Feb. 3, 2006

(30) Foreign Application Priority Data
Aug. 4, 2003 (FR) 0309594

(51) Int. Cl. A61C 1/08; A61C 5/02

(52) U.S. Cl. 433/126; 433/127; 433/102

(57) ABSTRACT

Endodontal contra-angle (1) equipped with a head (2) supporting an endodontal instrument (3), and with attachment means (5) for attaching a shank (4) penetrating the head (2) of the contra-angle (1), characterized in that said head (2) of the contra-angle is equipped with a member that is free to rotate (6), assembled fixedly to the body of said head (2).

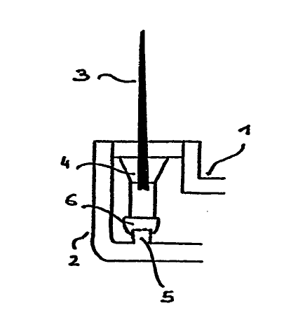

The subject of the present invention is a handpiece or contra-angle, used for endodontology.

The prior art already knows various instruments of this type, used either to prepare or to bore tooth canals. These instruments may be mechanized or manual; they may equally operate in continuous rotation or in reciprocating rotation. This rotational movement is allowed by virtue of a contra-angle piece on which the instrument is positioned. The instrument is generally equipped with a shank, defined by ISO 1797, penetrating the head of the contra-angle, which head is equipped with mechanical means allowing the instrument to be attached removably.

In this type of instrument known from the prior art, the user has always to remove the instrument from the shank each time he changes operation, and this increases the risks of prick injury and therefore the risks of contamination both as far as the user and as far as the patient are concerned.

Furthermore, the means for clamping the instrument onto the shank are bulky, which prevents small heads from being produced, thus restricting the visibility that the user has.

The invention proposes to remedy these various disadvantages by proposing an endodontal handpiece that does not require a change of instrument for each new operation.

To do this, the subject of the present invention is an endodontal contra-angle (1) equipped with a head (2) supporting an endontontal instrument (3), and with attachment means (5) for attaching a shank (4) penetrating the head of the contra-angle, characterized in that said head (2) of the contra-angle (1) is equipped with a member that is free to rotate (6), assembled fixedly to the body of said head (2).

The invention will be better understood with the aid of the description given hereinafter with reference to the attached drawing which depicts an endodontal handpiece according to the invention.

The contra-angle (1) is equipped with a head (2) on which a member (6) is positioned. This member will find itself free to rotate about the head (2) of the contra-angle (1) but will be permanently fixed to the body of the head (2). That allows the rotational movement of the instrument (3).

According to an advantageous characteristic of the invention, the contra-angle (1) is equipped with a head (2) made entirely of plastic, constituting a reusable part and thus limiting costs.

According to an advantageous characteristic of the invention, the member present on the head (2) of the contra-angle (1) is a pinion.

According to another advantageous characteristic of the invention, this pinion is made of a material which can be injection-molded, such as plastic.

According to an advantageous characteristic of the invention, a blade of a canal instrument is fixed to the pinion. The pinion is overmolded onto the blade of the canal instrument, thus securing these two elements together.

Although the invention has been described using particular embodiments, it encompasses all technical equivalents of the means described.

1-10. (canceled)

11. An endodontal contra-angle having a head for receiving an endodontal instrument so that the endodontal instrument is supported by the head, and which comprises:
a shank received by the head, wherein the shank penetrates the head of the contra-angle;
means for attaching the shank to the head of the contra-angle; and
a member associated with the head which is free to rotate within the head;
wherein the member is a pinion fixedly associated with body portions of the head, wherein the endodontal instrument includes a blade portion fixedly assembled on the pinion, and wherein the pinion is overmolded onto the blade portion of the instrument.

12. The endodontal contra-angle of claim 11 wherein the endodontal instrument is a canal instrument.

13. The endodontal contra-angle of claim 11 wherein the attachment means removably fixes the instrument on the shank.

14. The endodontal contra-angle of claim 11 wherein the pinion is made of an injection-moldable material.

15. The endodontal contra-angle of claim 14 wherein the injection-moldable material is a plastic.

16. The endodontal contra-angle of claim 11 wherein the contra-angle is a reusable part that accepts an equipment head.

17. The endodontal contra-angle of claim 11 wherein the contra-angle is made entirely of plastic.

18. The endodontal contra-angle of claim 11 wherein the contra-angle operates with a reciprocating movement.
